(19) United States
(12) Patent Application Publication
(10) Pub. No.: US 2026/0105828 A1
(43) Pub. Date: Apr. 16, 2026

(54) MANAGING A MAN-OVERBOARD SITUATION FOR A MARINE VESSEL

(71) Applicant: CPAC SYSTEMS AB, Göteborg (SE)

(72) Inventors: Jonatan BERGENWALL, Öjersjö (SE); Erik Lund, Mölndal (SE); Axel Måneskiöld, Göteborg (SE); Valter Strömberg, Mölndal (SE)

(73) Assignee: CPAC SYSTEMS AB, Göteborg (SE)

(21) Appl. No.: 19/350,849

(22) Filed: Oct. 6, 2025

(30) Foreign Application Priority Data
Oct. 11, 2024 (EP) 24206157.0

(51) Int. Cl. G08B 21/08; B63C 9/00

(52) U.S. Cl. CPC G08B 21/086; B63C 9/0005

(57) ABSTRACT

A computer system for managing a man-overboard, MOB, situation for a marine vessel has processing circuitry to receive an operator request and in response thereto activate the MOB mode by controlling activation of one or more sensors configured to monitor surroundings of the marine vessel; obtain sensing data from sensors identifying detectable features of a MOB; generate a MOB map based on the sensing data, the MOB map displaying graphical indications of a position of the MOB in relation to a position of the marine vessel; estimate said position of the MOB at least based on a latest known position of said at least one detectable feature and a current position of the marine vessel; and update the MOB map based on the estimation.

### TECHNICAL FIELD

The disclosure relates generally to safety at sea. In particular aspects, the disclosure relates to managing a man-overboard, MOB, situation for a marine vessel. The disclosure can be applied to marine vessels, such as leisure boats, ships, cruise ships, fishing vessels, yachts, ferries, among other vehicle types. Although the disclosure may be described with respect to a particular marine vessel, the disclosure is not restricted to any particular marine vessel.

### BACKGROUND

The management of a MOB situation is a critical aspect of marine safety, and may involve identification, location tracking, and rescue operations. MOB incidents can occur due to various factors including rough sea conditions, human error, or sudden medical emergencies. The timely and accurate response to such events is paramount in maximizing the chances of a successful rescue and ensuring the safety of individuals at sea.

The present inventors have identified a lack of efficient MOB management in the prior art, and are therefore suggesting improved approaches in this regard.

### SUMMARY

When a person falls overboard on a vessel, it is difficult to find that person, especially if the weather is bad and/or it is dark outside. Existing MOB management systems in the prior art often fall short in several areas, as they may rely on manual observation and basic onboard equipment, such as life rings with attached locator beacons. While these methods can provide initial alerts, they are often plagued by limitations that hinder effective rescue operations.

One drawback of prior art solutions is the lack of precise, real-time tracking of the MOB. Many existing systems are unable to continuously monitor and update the position of the MOB, leading to potential delays and inaccuracies in locating the individual. This lack of precision can be detrimental in dynamic marine environments where quick and accurate responses are important.

Another issue with existing MOB management systems is the propensity for false positives, which can confuse and overwhelm operators. False alarms can be triggered by various factors, such as debris or marine wildlife, leading to unnecessary diversions and wasted resources. This problem is exacerbated in modern electronic vessel systems that feature numerous electronic components, each demanding a portion of the operator's attention. Such false positives may not only complicate the rescue process but may also diminish the overall reliability and trust in the MOB system.

Furthermore, existing solutions are often not designed to adapt to evolving circumstances during a MOB incident. For example, they may not account for drift patterns caused by wind and currents, which typically alter the position of the MOB over time. The inability to dynamically adjust and update the MOB's location can compromise the effectiveness of the rescue mission.

In summary, there is a need for advancements in MOB management systems that address the shortcomings of the prior art mentioned above and others.

In a first aspect of the disclosure there is provided a computer system for managing a man-overboard, MOB, situation for a marine vessel, the computer system comprising processing circuitry configured to receive an operator request for activation of a MOB mode for the marine vessel; in response to receiving the operator request, activate the MOB mode by controlling activation of one or more sensors configured to monitor surroundings of the marine vessel; obtain sensing data from said one or more sensors identifying at least one detectable feature of a MOB in said surroundings of the marine vessel; generate a MOB map based on the sensing data, the MOB map displaying one or more graphical indications of a position of the MOB in relation to a position of the marine vessel; estimate said position of the MOB at least based on a latest known position of said at least one detectable feature and a current position of the marine vessel; and update the MOB map based on the estimation of the position of the MOB.

The first aspect of the disclosure may seek to address the difficulty in rapidly and accurately locating a person who has fallen overboard. A technical benefit may include providing precise, real-time tracking and mapping of the MOB's position, enhancing the efficiency and effectiveness of rescue operations.

Optionally in some examples, including in at least one preferred example, the processing circuitry is further configured to: identify one or more searchable areas in the MOB map; mark a searchable area as visited in response to the marine vessel having visited said searchable area based on its current position; and update the MOB map based on the marked searchable area. A technical benefit may include enhancing search efficiency by clearly identifying and marking searchable areas on the MOB map, allowing the crew to systematically cover potential locations of the MOB.

Optionally in some examples, including in at least one preferred example, the processing circuitry is further configured to: generate a search path for the marine vessel based on the one or more searchable areas and the position of the MOB in relation to the position of the marine vessel; and provide one or more navigational instructions based on the search path. A technical benefit may include optimizing navigation by generating a targeted search path and providing precise navigational instructions, ensuring thorough and efficient coverage of relevant areas.

Optionally in some examples, including in at least one preferred example, the processing circuitry is configured to automatically perform the estimation of the position of the MOB in response to a failure to obtain sensing data from the one or more sensors. A technical benefit may include maintaining continuous MOB tracking by automatically estimating its position even when sensor data is unavailable, ensuring uninterrupted rescue operations and potentially saving lives.

Optionally in some examples, including in at least one preferred example, the processing circuitry is further configured to: obtain environmental data of the surroundings of the marine vessel; and estimate said position of the MOB based on said environmental data. A technical benefit may include improving accuracy in MOB location estimation by integrating environmental data, which provides additional context for the MOB's movement.

Optionally in some examples, including in at least one preferred example, the obtained environmental data comprises one or more of wind speed, wind direction and current flow, and wherein the processing circuitry is configured to: calculate a drift vector for the MOB based on said one or more of wind speed, wind direction and current flow; and estimate the position of the MOB based on the drift vector. A technical benefit may include refining MOB position estimates by calculating a drift vector based on environmental factors such as wind and currents, enhancing predictive tracking capabilities.

Optionally in some examples, including in at least one preferred example, the estimation of the position of the MOB is continuous, and wherein the processing circuitry is configured to update the estimated position of the MOB at continuous intervals based on the movement of the marine vessel and the calculated drift vector. A technical benefit may include ensuring real-time adaptability by continuously updating the MOB's estimated position based on both vessel movement and environmental influences, maintaining accurate tracking.

Optionally in some examples, including in at least one preferred example, said at least one detectable feature is a reflective element and the sensing data is reflectivity data. A technical benefit may include increasing detection reliability by utilizing reflective elements as detectable features, thereby enhancing the system's ability to identify the MOB accurately.

Optionally in some examples, including in at least one preferred example, the reflective element comprises predetermined reflectivity properties, the processing circuitry being configured to map the obtained reflectivity data with said predetermined reflectivity properties to validate the identity of the MOB. A technical benefit may include validating MOB identity by mapping reflectivity data against predetermined properties, reducing false positives and ensuring precise identification.

Optionally in some examples, including in at least one preferred example, the processing circuitry is further configured to receive the operator request for activation of the MOB mode via an input device. A technical benefit of operator-initiated activation via an input device is the conservation of energy by activating sensors only when needed, thereby reducing false positives and ensuring critical systems remain operational for longer periods.

Optionally in some examples, including in at least one preferred example, the processing circuitry is further configured to display the MOB map at a display device of the marine vessel. A technical benefit may include enhancing situational awareness by displaying the updated MOB map on a vessel's display device, providing the crew with real-time visual information on the MOB's location.

In a second aspect of the disclosure there is provided a marine vessel comprising the computer system of the first aspect.

The second aspect of the disclosure may seek to address the difficulty in rapidly and accurately locating a person who has fallen overboard. A technical benefit may include providing precise, real-time tracking and mapping of the MOB's position, enhancing the efficiency and effectiveness of rescue operations.

In a third aspect of the disclosure there is provided a computer-implemented method for managing a man-overboard, MOB, situation for a marine vessel, comprising receiving, by processing circuitry of a computer system, an operator request for activation of a MOB mode for the marine vessel; in response to receiving the operator request, activating, by the processing circuitry, the MOB mode by controlling activation of one or more sensors configured to monitor surroundings of the marine vessel; obtaining, by the processing circuitry, sensing data from said one or more sensors identifying at least one detectable feature of a MOB in said surroundings of the marine vessel; generating, by the processing circuitry, a MOB map based on the sensing data, the MOB map displaying one or more graphical indications of a position of the MOB in relation to a position of the marine vessel; estimating, by the processing circuitry, said position of the MOB at least based on a latest known position of said at least one detectable feature and a current position of the marine vessel; and updating, by the processing circuitry, the MOB map based on the estimation of the position of the MOB.

The third aspect of the disclosure may seek to address the difficulty in rapidly and accurately locating a person who has fallen overboard. A technical benefit may include providing precise, real-time tracking and mapping of the MOB's position, enhancing the efficiency and effectiveness of rescue operations.

In a fourth aspect of the disclosure there is provided a computer program product comprising program code for performing, when executed by the processing circuitry, the method of the third aspect.

The fourth aspect of the disclosure may seek to enable new marine vessels and/or legacy marine vessels to be conveniently configured, by software installation/update, to address the difficulty in rapidly and accurately locating a person who has fallen overboard. A technical benefit may include providing precise, real-time tracking and mapping of the MOB's position, enhancing the efficiency and effectiveness of rescue operations.

In a fifth aspect of the disclosure there is provided non-transitory computer-readable storage medium comprising instructions, which when executed by the processing circuitry, cause the processing circuitry to perform the method of the third aspect.

The fifth aspect of the disclosure may seek to enable new marine vessels and/or legacy marine vessels to be conveniently configured, by software installation/update, to address the difficulty in rapidly and accurately locating a person who has fallen overboard. A technical benefit may include providing precise, real-time tracking and mapping of the MOB's position, enhancing the efficiency and effectiveness of rescue operations.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary marine vessel, according to an example.

FIG. 2 is an exemplary schematic illustration of components involved in the management of a MOB situation, according to an example.

FIG. 3A is an exemplary schematic illustration of managing a MOB situation, showing a first part of a search procedure where a crew member falls overboard, according to an example.

FIG. 3B is a continuation of the exemplary schematic illustration of FIG. 3A, showing a second part of the search procedure where a search has been initiated.

FIG. 3C is a continuation of the exemplary schematic illustration of FIG. 3B, showing a third part of the search procedure where a search path is followed towards an estimated position of a MOB.

FIG. 3D is a continuation of the exemplary schematic illustration of FIG. 3C, showing a fourth part of the search procedure where a search path is finished and a safety distance to the MOB is maintained.

FIG. 4 is an exemplary flowchart illustration of a method for managing a MOB situation for a marine vessel, according to an example.

FIG. 5 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The present disclosure addresses one or more of the deficiencies mentioned above by introducing approaches for managing a MOB situation for a marine vessel. The approaches involve receiving an operator request for activation of a MOB mode. Upon receiving this request, the activation of one or more sensors is controlled to monitor the surroundings of the marine vessel. Sensing data is obtained from these sensors to identify at least one detectable feature of the MOB, and a MOB map is generated which displays graphical indications of the MOB's position relative to the vessel's position. The position of the MOB is estimated based on the latest known position of the detectable feature and the current position of the marine vessel, updating the MOB map accordingly. This solution may ensure precise, real-time tracking, enhance situational awareness, reduce false positives, and adapt to changing environmental conditions, thereby improving the safety and efficiency of MOB rescue operations.

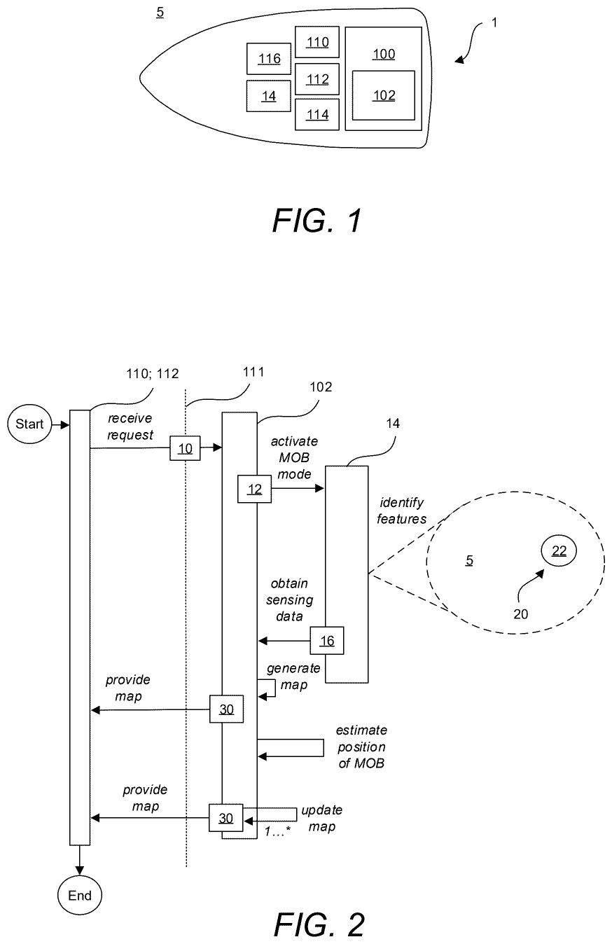

FIG. 1 is an exemplary marine vessel 1 where aspects and examples described herein can be applied. In non-limiting examples, the marine vessel 1 is a leisure boat, ship, cruise ship, fishing vessel, yacht, ferry, or the like. The marine vessel 1 is adapted to operate in surroundings 5 at bodies of water, e.g., a sea, ocean, lake, river, bay, gulf, strait, channel, reservoir, fjord, marsh, swamp, etc. The surroundings 5 can include a variety of obstacles and environmental features. These surroundings 5 often involve other vessels, islands, marine wildlife, submerged objects, floating debris, and other common obstacles found in marine environments. The marine vessel 1 may be an electric marine vessel, gasoline-powered marine vessel, diesel-powered marine vessel, or the like.

The marine vessel 1 comprises a computer system 100 having processing circuitry 102. The processing circuitry 102 is a central component responsible for executing various functions related to MOB management. It is designed to process input from one or more components, execute algorithms for real-time tracking and estimation, and generate visual representations.

The marine vessel 1 comprises an input device 110 having a user interface. This user interface can be designed to support multiple forms of input to cater to different operational environments and user preferences. Examples may include voice commands, touchscreens, or haptic feedback mechanisms. Variations may include combined input methods, such as voice and touch. The input device 110 may be integrated in a display device, such as being a touch panel at the display device 112. The input device 110 may be a separate device, such as a physical MOB actuator (e.g. a button) actuatable by the operator. Such a physical actuator is preferably easily accessible by the operator so that the mode can be triggered as soon as possible. The input device 110 may yet alternatively be an input device of a portable device, such as a mobile phone or tablet, such that inputs can be sent remotely to the processing circuitry 102. Inputs via the input device 110 may cause the triggering of an operator request for activation of a MOB mode 12.

The marine vessel 1 comprises a display device 112 having a user interface. Typically, this interface is graphical, such as a digital display screen mounted on the vessel's 1 control panel. The display device 112 provides visual feedback in the form of graphical indications. The display device 112 may be complemented with audio alerts that inform the operator of events and/or actions required. Additionally, haptic feedback can be integrated with the display device 112 to provide tactile alerts, ensuring the operator is aware of important notifications even in noisy or visually cluttered environments. Variations of the display device 112 may include heads-up displays (HUDs) for augmented reality navigation or portable devices that can be carried by crew members.

The marine vessel 1 comprises an advanced driver assistance system (ADAS) 114. The ADAS integrates with the computer system 100 to provide navigational aids and automate certain functions such as steering and throttle control. The ADAS 114 utilizes data from onboard sensors and environmental data services to maintain navigation paths and improve the efficiency of rescue operations. For example, the ADAS 114 can automatically adjust the vessel's 1 course to avoid obstacles while navigating towards the MOB. Variations of the ADAS 114 may include adaptive cruise control for maintaining safe speeds, collision avoidance systems, and automated docking features.

The marine vessel 1 comprises an environmental data service 116. The environmental data service 116 is responsible for collecting and processing environmental data relevant to the vessel's 1 operation. Examples of such data include one or more of wind speed and direction, sea currents, weather conditions, and water temperature. The environmental data service 114 interfaces with the processing circuitry 102 to provide inputs that can enhance the accuracy of MOB position estimation and decision-making processes. Variations of the environmental data service 116 may include integration with satellite-based weather forecasting systems, real-time oceanographic data services, and/or local environmental sensors deployed around the vessel 1.

The marine vessel 1 comprises one or more sensors 14, which can include but are not limited to lidar, sonar, radar, and cameras. These sensors may be arranged around the vessel 1 to monitor its surroundings 5 and detect a MOB. Lidar sensors provide high-resolution 3D mapping capabilities, sonar sensors are effective in underwater detection, radar sensors offer long-range detection in various weather conditions, and cameras provide visual confirmation and identification. The sensing data obtained from these sensors are processed by the processing circuitry 102 to identify one or more detectable features of the MOB. Variations of the sensor suite may include thermal cameras for detecting heat signatures, infrared sensors for night-time operations, and multi-spectral sensors for enhanced detection capabilities in diverse environments.

FIG. 2 is an exemplary schematic illustration of components involved in the management of a MOB situation. The process starts by receiving an operator request 10 for activation of a MOB mode 12 for the marine vessel 1. This request 10 may be provided via a user interface 111 to the processing circuitry 102 from an input device 110. A MOB situation refers to an incident where a person falls overboard from the marine vessel 1, necessitating rescue operations to ensure the individual's safety. Such situations can arise due to various factors, including rough sea conditions, human error, sudden medical emergencies, or accidents.

The operator request 10 is a command initiated by an individual, typically a crew member or the vessel operator, to activate specific functionalities of the MOB management system. This request can be made through various means, depending on the design and capabilities of the user interface 111. The operator request 10 triggers a system response to the MOB situation, to thereby activate a MOB mode 12. The MOB mode 12 is thus an operational state of the marine vessel 1, activated in response to the operator request 10. The MOB mode 12 refers to a distinct configuration or state in which the computer system 100 operates to perform specific functions tailored to particular needs or scenarios. In the context of MOB management, activating the MOB mode 12 initiates a series of predefined actions and system behaviors designed to manage and resolve the MOB situation effectively.

Upon receiving the operator request 10, the processing circuitry 102 activates the MOB mode 12 by controlling the activation of one or more sensors 14 configured to monitor the surroundings 5 of the marine vessel 1. This activation process is associated with power conserving benefits and the reduction of false positives, which are concerns in maritime environments. The activation control involves the processing circuitry 102 sending specific signals to initiate the operation of the sensors 14. This can be done in various ways, such as simultaneous activation, where all sensors 14 are activated together to provide immediate and comprehensive monitoring, sequential activation, where sensors 14 are activated in a pre-determined sequence ensuring step-by-step coverage of the surroundings, or pattern-based activation where sensors are activated based on a specific pattern that prioritizes certain areas or types of monitoring depending on the situation's requirements. For example, the processing circuitry 102 might first activate radar sensors to scan for large obstacles and then follow up with optical cameras for detailed visual confirmation. This strategy can ensure efficient use of sensors and improve power conservation.

Activating sensors 14 in response to the operator request 10, rather than having them always on or automatically triggered, offers several advantages. At sea, power resources can be limited, especially on smaller vessels. Activating the sensors 14 only when needed conserves energy, which may ensure that systems, oftentimes of critical character, remain operational for longer periods. Moreover, continuous operation or automatic triggers can lead to numerous false positives, confusing the operator and potentially delaying the rescue process. Operator-initiated activation allows for more controlled and accurate detection.

Monitoring the surroundings 5 refers to the sensors'14 capability to detect and analyze various elements in the vessel's 1 environment. This includes identifying other vessels, obstacles, islands, marine wildlife, and any other potential hazards or objects of interest, as mentioned above. The monitoring may ensure that the vessel 1 can navigate safely and respond promptly to MOB situations.

In some examples, the processing circuitry 102 may be configured to display a confirmation prompt at a display device 112 of the marine vessel 1 in response to receiving the operator request 10. The display device 112, typically a graphical user interface, shows a prompt asking the operator to confirm the activation of the MOB mode 12. Upon receiving a confirmation input from the operator via the display device, the processing circuitry 102 activates the MOB mode 12. This two-step verification process may ensure that the activation is deliberate and reduce the risk of accidental triggers. It can thus provide an additional layer of security, confirming the operator's intent before mobilizing system resources.

In examples where the marine vessel 1 is a sailboat, the processing circuitry 102 may be configured to control the automatic navigation of the sailboat into the wind eye and/or manage the deployment of one or more sails. The “wind eye”, also known as the “no-sail zone”, is the area directly upwind where a sailboat cannot sail effectively. By navigating into the wind eye, the sailboat can be brought to a near standstill, which is often beneficial in a MOB situation. In addition, the processing circuitry 102 may be configured to start an engine via e.g. sending control signals thereto. This maneuver helps to stabilize the vessel 1 and reduce its forward momentum, making it easier to conduct the rescue operation without endangering the MOB 20 or complicating the retrieval process. The processing circuitry 102 may achieve this by interfacing with the sailboat's automatic navigation system. The processing circuitry 102 may calculates the desired heading to steer the vessel 1 into the wind eye and adjust the rudder and sails accordingly. In addition or as an alternative to controlling the navigation, the processing circuitry 102 can also manage the deployment of the sails. Depending on the situation, the system may furl (roll up) or reef (reduce the size of) the sails to reduce wind propulsion and further stabilize the sailboat. This can be particularly useful in strong wind conditions, where full sails could make the vessel 1 difficult to control. The capability to automatically navigate into the wind eye and control sail deployment may offer several advantages. It may reduce the need for manual intervention by the crew, allowing them to focus on the rescue operation. It may also enhance the safety and stability of the vessel 1 during the critical moments of retrieving the MOB 20, reducing the risks associated with uncontrolled movement or excessive speed.

After activating the MOB mode 12, the process continues by the processing circuitry 102 obtaining sensing data 16 from one or more of the sensors 14. The sensing data 16 can refer to raw or processed information collected by the sensors 14 deployed on the vessel 1. The sensing data 16 can take various forms depending on the type of sensor technology employed. The sensing data 16 can be gathered using both “dumb” sensors and “smart” sensors 14. Dumb sensors 14 typically provide raw measurements without any internal processing, such as time-of-flight measurements from sonar or radar sensors that determine the distance to an object based on the time it takes for a signal to return. Smart sensors, on the other hand, may include built-in capabilities for image analysis or preliminary data processing, such as cameras with feature recognition or infrared sensors that can identify heat signatures.

The processing circuitry 102 is designed to handle and process all types of sensing data 16, whether it is raw measurements from dumb sensors or pre-processed data from smart sensors. This versatility assists the computer system 100 to effectively integrate and analyze various data streams to identify a MOB 20.

The sensing data 16 identifies at least one detectable feature 22 of the MOB 20. The detectable feature 22 refers to any characteristic or attribute of the MOB 20 that can be identified and tracked by the sensors 14. Detectable features 22 can include, but are not limited to, visual markers such as color or shape, reflective elements, heat signatures, or movement patterns. These features are used for differentiating the MOB 20 from other objects in the surroundings and ensuring accurate tracking. There can be many detectable features 22 associated with one MOB 20, or multiple MOBs 20 may have their own unique set of detectable features 22.

In some examples, the detectable feature 22 is a reflective element, and the sensing data 16 is reflectivity data. Reflective elements are materials or objects that reflect sensor signals, such as radar or lidar pulses, back to the source. These elements can be integrated into life jackets, personal flotation devices, or clothing to enhance their detectability in the water.

The reflective element may comprise predetermined reflectivity properties. The processing circuitry 102 is configured to map the obtained reflectivity data with these predetermined reflectivity properties to validate the identity of the MOB 20. This may involve comparing the sensed reflectivity patterns with known characteristics of the reflective element to confirm that the detected object is indeed the MOB 20. For instance, the processing circuitry 102 might recognize a specific type of reflective tape on a life jacket, ensuring that the tracking is accurate and further reducing the likelihood of false positives. This can distinguish certain reflective elements from others, for example such that false positives are not generated for the detection of a reflective element of a buoy (or similar), when looking for a reflective element of a life vest of the MOB 20.

The procedure follows with the generation of a MOB map 30 based on the sensing data 16. The MOB map 30 is a digital representation of the marine vessel's 1 surroundings 5, including any detected objects and the marine environment. The MOB map 30 is created by processing the sensing data 16 to render a visual layout that depicts the spatial arrangement of various elements around the vessel. The MOB map 30 may be used for providing real-time situational awareness to the vessel's 1 crew.

Graphical indications on the MOB map 30 are visual markers that represent the position of specific objects, for example the MOB 20 thanks to its detectable feature(s) 22. These indications can take various forms, such as icons, symbols, or highlighted areas, designed to be recognizable by the operator. The position of the MOB 20 in relation to the position of the marine vessel 1 is depicted using coordinates or reference points that show where the MOB 20 is located relative to the vessel's 1 current location. This may involve calculating the MOB's 20 position using data from the sensors 14 and representing it on the MOB map 30 with respect to the vessel's coordinates, for example using a grid or compass-based system for accuracy.

In some examples, the processing circuitry 102 may be is further configured to display the MOB map 30 at a display device 112 on the marine vessel 1 (i.e., to “provide” the MOB map 30). The display device 112, typically including graphical user interface as discussed above, shows the MOB map 30, preferably in real-time, complete with graphical indications of the MOB's 20 position in relation to the vessel 1. This allows the operator to have visual access to critical information, facilitating quick and informed decision-making during a rescue operation. The MOB map 30 displayed on the display device 112 provides a comprehensive view of the current situation, highlighting the MOB's 20 location and any relevant environmental features. For example, if the MOB 20 is detected to the starboard side of the vessel 1, the MOB map 30 may show the position relative to the vessel's 1 bow and stern, enabling the crew to navigate towards the MOB 20.

The next step in the process involves estimating the position of the MOB 20 based on the latest known position of at least one detectable feature 22 and the current position of the marine vessel 1. The term “estimate” refers to a calculated approximation of the MOB's 20 location, which may involve some level of uncertainty or error margin. The “latest known position” of the detectable feature 22 is the most recent spatial data point where the feature was observed by the sensors 14. This can be known by continuously storing the positional data of the detectable feature 22 as it is monitored. The processing circuitry 102 may keep a record of these positions in a data storage unit and fetch the most recent one when needed for estimation. This stored data allows the processing circuitry 102 to track movement patterns and predict the current position of the MOB 20 by comparing it to the positional data of the marine vessel 1.

The positional data of the marine vessel 1 in relation to the MOB 20 can be known using various methods. One common method is GPS or other global position data (e.g. GNSS/GLONASS), which provides precise global coordinates for both the vessel 1 and the MOB 20. However, GPS is not necessary, as relative positional differences may be sufficient. Other methods include using onboard navigation systems that track the vessel's 1 movement through inertial measurement units (IMUs) like accelerometers, gyroscopes and magnetometers. These onboard navigation systems can provide the position of the marine vessel 1 relative to a known starting point or in relation to the detected MOB 20. For example, the processing circuitry 102 can use radar, sonar or lidar data to measure the distance and angle of the MOB 20 from the vessel 1. By combining this information with the vessel's 1 own positional data, the processing circuitry 102 can estimate the current position of the MOB 20. This relative positioning method may be useful in situations where GPS signals may be weak or unavailable, such as in dense fog or heavy storms.

The estimation may be particularly effective in cases where the processing circuitry 102 experiences a failure to obtain sensing data 16 from the one or more sensors 14. In these cases the processing circuitry 102 may be configured to automatically perform the estimation of the MOB's 20 position in such occurrences. A failure to obtain sensing data 16 can occur due to various reasons, such as sensor malfunctions, obstructions, or adverse environmental conditions that impede the sensors'14 ability to collect accurate data. When this happens, the processing circuitry 102 is automatically controlled to instead of the sensing data 16 rely on the estimation.

The processing circuitry 102 may be configured to enhance the accuracy of MOB position estimation by utilizing historical location data of previous MOB incidents. Historical location data refers to the recorded positions and movements of past MOB events that have been stored, such as in the data storage unit described above. Previous MOB incidents are past occurrences where individuals fell overboard, and their locations and rescue outcomes were documented. By analyzing this data, the processing circuitry 102 can detect patterns and predict the likely movements of the MOB 20 based on similar past events. For instance, if historical data shows that MOBs tend to drift a certain distance in a specific direction under similar environmental conditions, the system can use this information to refine its current estimation.

For example, the marine vessel 1 may obtain historical location data from one or more other marine vessels that have previously operated or are currently operating in corresponding surroundings 5 as the marine vessel 1, and/or from offboard systems such as a fleet manager system. This data can be valuable in improving the accuracy and reliability of MOB position estimations. One example of obtaining such historical location data is through an Automatic Identification System (AIS). AIS is a maritime communication system that allows vessels to exchange real-time information about their positions, movements, and other relevant data. The AIS data is typically transmitted over Very High Frequency (VHF) radio waves, ensuring a broad range of coverage and reliable communication even in remote areas. By integrating AIS data, the computer system 100 can access a wealth of historical location information from other vessels. This includes data on previous MOB incidents, typical drift patterns in specific environmental conditions, and the movement trajectories of other vessels in the vicinity. The processing circuitry 102 can retrieve this AIS data and use it to enhance the current MOB position estimation.

For instance, if the AIS data indicates that other vessels in similar surroundings have encountered MOB situations where the individuals drifted in a particular direction due to prevailing currents and winds, this information can be used to predict the likely movement of the current MOB 20. By comparing the AIS data with real-time environmental data, the processing circuitry 102 can dynamically adjust the MOB's estimated position, providing a more accurate and reliable tracking solution. This integration of AIS data not only leverages the collective experience of multiple vessels but also ensures that the system remains up-to-date with the latest navigational and environmental conditions. Consequently, the use of AIS data may enhance the situational awareness of the crew, enabling more informed decision-making and improving the overall effectiveness of the rescue operation.

Following the examples above, the processing circuitry 102 may also be configured to obtain other types of information via AIS data, such as environmental data obtained by one or more other vessels'respective computer systems.

The processing circuitry 102 can be further configured to improve MOB position estimation by obtaining environmental data of the surroundings 5 of the marine vessel 1. The environmental data may include parameters such as wind speed, wind direction, sea currents, and weather conditions. These factors influence the movement of the MOB 20, especially in more severe weather conditions, and are thus accounted for in some examples to ensure accurate tracking estimation.

Based on the environmental data, the processing circuitry 102 may be configured to calculate a drift vector. In these contexts, the drift vector is a mathematical representation of the MOB's 20 movement influenced by environmental conditions. The drift vector may be defined as a vector that combines the effects of wind speed, wind direction, and current flow. Mathematically, if \vec{W} represents the wind vector (indicating wind direction and wind strength) and \vec{C} represents the current vector, the drift vector \vec{D} can be expressed as \vec{D}=\vec{W}+\vec{C}. This vector indicates both the direction and magnitude of the MOB's 20 drift, allowing the processing circuitry 102 to estimate its position more accurately.

The estimation process may involve a continuous update of the MOB's 20 position as new sensing data is obtained. This dynamic updating can ensure that the estimated position remains as accurate as possible, allowing the crew to effectively navigate towards the MOB 20. The processing circuitry's 102 ability to adapt to changing conditions and incorporate various data sources makes it a robust tool for managing MOB situations and enhancing the safety of individuals at sea. Continuous intervals refer to regularly spaced time intervals at which the processing circuitry 102 recalculates the MOB's 20 position. For example, the processing circuitry 102 might update the estimation every second or every few seconds, depending on the processing capabilities and the urgency of the situation. The estimation process may take into account both the movement of the marine vessel 1 and the calculated drift vector. As the vessel 1 moves, its position relative to the MOB 20 changes, requiring constant recalculations to maintain accurate tracking. By integrating the vessel's 1 global positioning data or relative positional data with the drift vector, the processing circuitry 102 may provide a dynamic and precise estimation of the MOB's 20 current location.

The process continues by updating the MOB map 30 based on the estimation of the position of the MOB 20. This may be done one or more times (1 . . . * as indicated in the figure). This is for maintaining real-time situational awareness and ensuring that the rescue operation can adapt to any changes in the MOB's 20 location and optionally environmental conditions. Once the processing circuitry 102 has estimated the position of the MOB 20, this information is used to update the graphical indications on the MOB map 30. The MOB map 30 may thus be a dynamic digital representation that continuously reflects the latest data about the MOB's 20 position relative to the marine vessel 1.

The processing circuitry 102 recalculates the MOB's 20 position at continuous intervals, integrating new sensing data, changes in the vessel's 1 movement, and optionally environmental factors such as wind speed, wind direction, and current flow. The updated MOB map 30 displays real-time graphical indications of the MOB's 20 position, which can include icons, symbols, or highlighted areas that are easy for the operator to recognize. These indications help the crew to quickly identify the MOB's 20 location and adjust their navigation accordingly. The map can also include additional information, such as the estimated drift vector and the current position of the vessel, providing a comprehensive view of the rescue scenario.

For example, if the MOB 20 is drifting due to strong currents, the updated MOB map 30 may show the new position of the MOB 20, accounting for this drift. The processing circuitry 102 may also display a predicted drift path 21 of the MOB 20 based on the calculated drift vector, allowing the crew to anticipate future movements and plan their rescue efforts more effectively.

Similar to the initial map generated based on the sensing data 16, the processing circuitry 102 may be configured to display the updated MOB map 30 on the display device 112 of the marine vessel 1. The display device 112 may provide additional features such as zooming in and out, panning across different areas of the MOB map 30, and overlaying various data layers, such as environmental conditions and vessel navigation paths. These features allow the crew to customize their view and focus on the most relevant information for the rescue operation.

In some examples, the processing circuitry 102 may be configured to automatically deactivate the MOB mode 12 by controlling the deactivation of one or more sensors 14 in response to the successful retrieval of the MOB 20. This process can ensure that the system transitions smoothly from the active search and rescue phase to a normal operational state once the MOB has been safely recovered. Upon confirming the successful retrieval of the MOB 20, which can be detected through various means such as manual input from the operator, sensor confirmation, or integration with other onboard systems like cameras or RFID tags, the processing circuitry 102 sends signals to deactivate the sensors that were actively monitoring the surroundings. This process may conserve power by shutting down sensors 14 that are no longer needed, which may be important in maritime environments where power resources may be limited. It may also reduce the cognitive load on the operator by automating the transition process, allowing the crew to focus on post-rescue procedures and the well-being of the retrieved individual. It can also reduce the risk of false positives or unnecessary alerts by ensuring that the system is only active when required.

The deactivation process may involve systematically turning off the sensors 14 in a controlled manner to ensure that all components return to their standby or normal operational states without causing disruptions or errors. This may include powering down radar, sonar, lidar, and optical cameras that were used during the MOB mode 12. The processing circuitry 102 can ensure that this process is smooth and does not interfere with other systems onboard the marine vessel 1.

The deactivation process may also be manually performed, for example using similar techniques as to how it was activated.

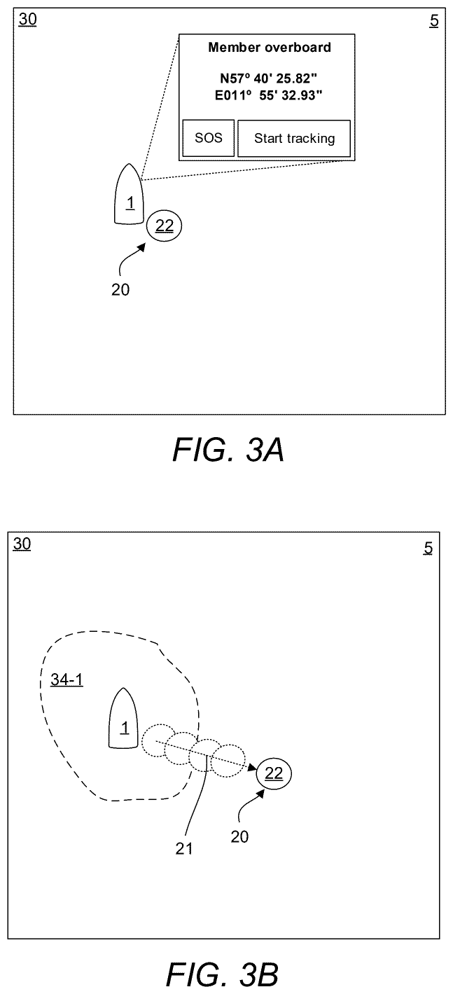

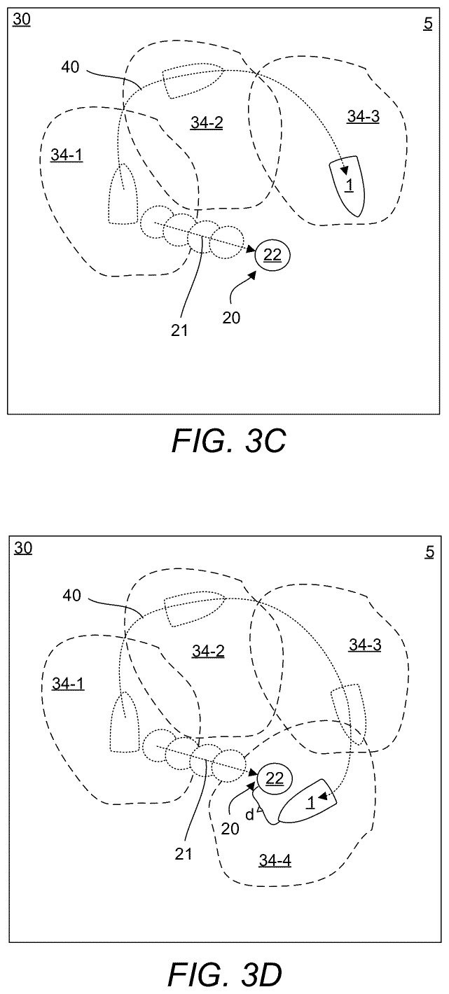

The process does not necessarily end here. On the contrary, the present disclosure presents one or more additional steps that can be included in the management of the MOB situation. These will now be explained in more detail according to the exemplary visualizations of FIGS. 3A-D.

FIG. 3A depicts an initial phase of a search procedure when a crew member falls overboard. This figure provides a visual representation of the sequence of events and system responses that occur immediately following the detection of a MOB incident. When a crew member falls overboard, the first action is for the operator to recognize the incident and send an operator request to activate the MOB mode 12. As mentioned above, the operator may be any member of the crew of the vessel 1. This request is typically made through an input device, such as a touchscreen, button, or voice command, which communicates with the processing circuitry 102 of the computer system 100. The activation of the MOB mode 12 triggers the system 100 to initiate a series of predefined actions designed to manage the MOB situation effectively.

Once the MOB mode 12 is activated, the processing circuitry 102 controls the activation of one or more sensors 14 configured to monitor the surroundings 5 of the marine vessel 1. These sensors 14, which can include radar, sonar, lidar, and cameras, start scanning the environment to detect the MOB 20. In this scenario, the MOB 20 has a detectable feature 22, such as a life vest with a specific reflectivity value that can be identified. As the sensors 14 collect sensing data 16, the processing circuitry 102 analyzes this data to identify the MOB's 20 detectable feature 22. The processing circuitry 102 then generates a MOB map 30 based on this analyzed data. On the MOB map 30, graphical indications represent the position of the MOB 20 and its detectable feature 22. For instance, the life vest's reflectivity value might be highlighted with a specific icon or color on the map, making it easily recognizable to the operator. The MOB map 30 also displays the current position of the marine vessel 1, allowing the crew to see the exact location of the MOB 20 in relation to the vessel's 1 position.

In FIG. 3A, the display device 112 receives a prompt asking the operator to confirm the activation of the MOB mode 12, effectively initiating the tracking of the MOB. Additionally or alternatively, the prompt may include an SOS option, allowing the operator to call for external aid if necessary. The display window also presents the latest coordinates where the MOB 20 was identified, providing the operator with information to begin the rescue operation promptly and efficiently. While not explicitly shown in the other visualizations of other parts of the rescue procedure, this information may persist throughout the rescue operation.

FIG. 3B is a continuation of the exemplary schematic illustration shown in FIG. 3A, depicting a second part of the search procedure where the search for the MOB 20 has been initiated. In this phase, the MOB 20 has started to drift away from the marine vessel 1, necessitating further action to ensure a successful rescue. As the MOB 20 begins to drift, the sensors 14 and processing circuitry 102 continue to monitor and analyze the surroundings 5. The drift path 21 of the MOB 20 is highlighted on the MOB map 30, providing a graphical indication of the direction and distance the MOB 20 is moving away from the vessel 1. This drift path 21 is represented by directional arrows or lines on the MOB map 30, showing the estimated trajectory based on the current environmental conditions such as wind speed, wind direction, and current flow. An position estimation of the MOB 20 complements the sensing data 16 for discovering and updating the position of the MOB 20.

The processing circuitry 102 is configured to identify a searchable area 34-1 on the MOB map 30. This searchable area 34-1 is a region where the MOB 20 is likely to be found based on its drift path 21 and are prioritized for the search operation. As the marine vessel 1 navigates through the searchable area 34-1, the processing circuitry 102 marks the area 34-1 as visited. This marking process is based on the vessel's 1 current position, which is continuously updated using methods described herein. When the vessel 1 enters the searchable area 34-1, the processing circuitry 102 records this action and visually updates the MOB map 30 to indicate that the area 34-1 has been searched. This can be done using color changes, checkmarks, or other graphical indicators to differentiate between searched and unsearched areas. Updating the MOB map 30 based on the marked searchable area 34-1 can ensure that the crew has a clear and organized view of the search progress. It may help to prevent redundant searches and allows the crew to focus their efforts on areas that have not yet been covered. This systematic approach enhances the efficiency of the rescue operation by ensuring that potential locations of the MOB 20 are thoroughly investigated.

FIG. 3C continues from FIG. 3B, illustrating a third part of the search procedure where the marine vessel 1 follows a systematic search path 40 towards the estimated position of the MOB 20. In this phase, the vessel 1 navigates through additional searchable areas 34-1, 34-2, 34-3 while adhering to a calculated search path 40. As the vessel 1 travels between these areas 34-1, 34-2, 34-3, it marks each area 34-1, 34-2, 34-3 as visited, updating the MOB map 30 to reflect the progress of the search. The searchable areas 34-1, 34-2, 34-3 are dynamically identified based on the latest estimation of the MOB's 20 position, and the search path 40 is designed to cover these areas efficiently. This can ensure that no potential location is overlooked and enhances the likelihood of locating the MOB 20.

The search path 40 is generated by the processing circuitry 102, taking into account the position of the MOB 20 in relation to the vessel's 1 current position. The path 40 may be adapted to balance thoroughness and speed, guiding the vessel 1 through the searchable areas 34-1, 34-2, 34-3 and ultimately leading it to the estimated position of the MOB 20. Once the search path 40 is generated, the processing circuitry 102 provides one or more navigational instructions 42 to guide the vessel 1 along this path 40. These instructions can include specific headings, speeds, and maneuvers required to navigate through the searchable areas. The navigational instructions 42 may be displayed on the display device 112.

The search path 40 may be adapted based on the obtained environmental data, allowing for dynamic adjustments to the vessel's 1 search strategy. For example, if the environmental data indicates strong currents or high winds, the processing circuitry 102 can modify searchable areas 34 to be larger, accounting for the increased drift of the MOB 20. This can ensure that the search remains effective even under challenging conditions. By considering factors such as water currents, wind speed, and visibility, the system can improve the search path 40 to increase the likelihood of locating the MOB 20 quickly and safely.

In some examples, the processing circuitry 102 may be further configured to cause autonomous control of the marine vessel 1 to follow the search path 40 based on the provided navigational instructions 42. This means that the processing circuitry 102 can take over control of the vessel's 1 navigation, steering it along the predefined path without requiring manual input from the crew. This may be done by control via the ADAS 114. The ADAS 114 continuously monitors the vessel's 1 position, adjusts its course as needed, and ensures that the search path 40 is followed. This autonomous capability may be particularly valuable in situations where the crew may be occupied with other tasks, when precise navigation is critical to the success of the rescue operation, or when the sight is bad due to darkness and/or fog. By incorporating autonomous control, the processing circuitry 102 may reduce the cognitive load on the crew and increase the efficiency of the search procedure. The processing circuitry 102 allows the vessel 1 to navigate through complex environments and maintain an optimal search pattern, ultimately improving the chances of locating and rescuing the MOB 20.

FIG. 3D follows from FIG. 3C, illustrating a fourth part of the search procedure where the search path 40 is completed, and a safety distance d is maintained from the MOB 20. As the marine vessel 1 navigates through the predefined search path 40 and systematically visits the searchable areas 34-1, 34-2, 34-3, it ultimately arrives at the estimated position of the MOB 20, located in the area 34-4.

Maintaining a safety distance d from the MOB 20 can ensure that the vessel 1 does not inadvertently harm the individual in the water with e.g. its propellers or hull. This safety distance d is visually represented on the MOB map 30, providing the crew with a clear indication of the boundary that should not be crossed. The processing circuitry 102 can enforce this safety distance d by controlling the vessel's 1 movements and ensuring it remains at a safe distance from the MOB 20 while facilitating the rescue operation.

In some examples, the processing circuitry 102 may be configured to adapt the safety distance d based on one or more properties of the marine vessel 1 and obtained environmental data of the surroundings 5. Properties of the vessel can include its size, maneuverability, and speed, while environmental data can include factors such as wind speed, wind direction, sea currents, and weather conditions. By considering these variables, the processing circuitry 102 can dynamically adjust the safety distance. For instance, in rough sea conditions, a larger safety distance might be necessary to account for the vessel's 1 movement and ensure the MOB's 20 safety.

In some examples, the processing circuitry 102 may be configured to calculate an error margin for the estimated position of the MOB 20 and adjust the search path 40 to account for this error margin. An error margin represents the potential deviation in the estimated position due to uncertainties or inaccuracies in the sensing data 16 and environmental conditions. By calculating this margin, the processing circuitry 102 can adjust the search path 40 to ensure that all possible locations of the MOB 20 are covered, increasing the likelihood of a successful rescue. For example, if the error margin indicates that the MOB's 20 position could vary within a certain radius, the search path 40 may be adjusted to encompass this entire area, ensuring no potential location is overlooked. This can be done by identifying one or more additional searchable areas 34, or adapting the size of one or more searchable areas 34. This proactive approach can enhance the thoroughness of the search operation and mitigate the risks associated with estimation errors.

According to the above, FIGS. 3A-D illustrate a comprehensive search procedure for managing a man-overboard (MOB) situation, starting with the initial detection and activation of MOB mode, followed by the systematic search and tracking of the MOB 20. In FIG. 3A, the operator activates the MOB mode, leading to the generation of a MOB map 30 that highlights the MOB's 20 detectable features 22. FIG. 3B shows the identification of a searchable area 34-1 and the marking of this area 34-1 as visited, while FIG. 3C demonstrates the marine vessel 1 following a calculated search path 40 through many areas 34-1, 34-2, 34-3 to locate the MOB 20. Finally, in FIG. 3D the MOB 20 is found in the area 34-4, which further emphasizes maintaining a safety distance d from the MOB 20. Optionally, the search path 40 may be adjusted dynamically on the basis of an error margin to ensure a thorough and safe rescue operation.

It shall be understood that the searchable areas 34 may be of any size, dimension and/or number, the search path 40 may be any length with any number of turns (to e.g. avoid obstacles/landmasses), the map 30 cover any suitable sea range (e.g. ranging from tens of meters for small areas up to many kilometers for larger areas), the safety distance d be of any length/direction, the MOB's 20 drift path 21 of any length/direction, and so forth. The MOB operation will depend on factors explained herein, such as vessel properties, environment data, MOB characteristics, etc.

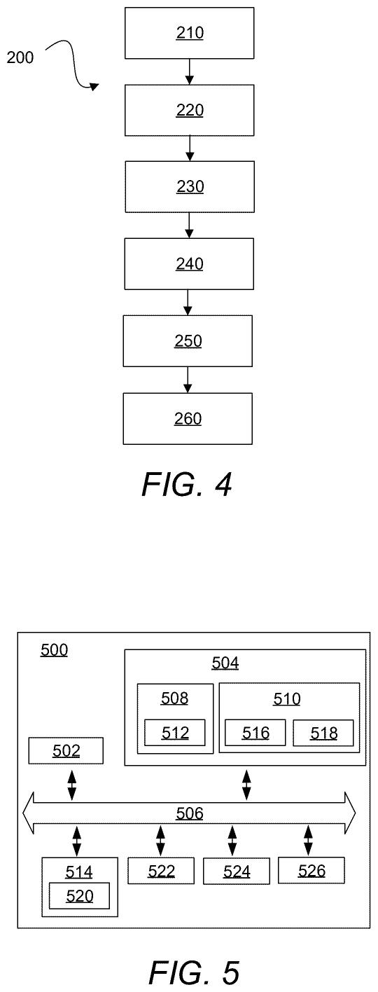

FIG. 4 is a flowchart of a computer-implemented method 200 for managing a MOB situation for a marine vessel. The method 200 is carried out by processing circuitry of a computer system. The method 200 comprises receiving 210 an operator request for activation of a MOB mode for the marine vessel. The method 200 further comprises, in response to receiving the operator request, activating 220 the MOB mode by controlling activation of one or more sensors configured to monitor surroundings of the marine vessel. The method 200 further comprises obtaining 230 sensing data from said one or more sensors identifying at least one detectable feature of a MOB in said surroundings of the marine vessel. The method 200 further comprises generating 240 a MOB map based on the sensing data, the MOB map displaying one or more graphical indications of a position of the MOB in relation to a position of the marine vessel. The method 200 further comprises estimating 250 said position of the MOB at least based on a latest known position of said at least one detectable feature and a current position of the marine vessel. The method 200 further comprises updating 260 the MOB map based on the estimation of the position of the MOB.

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

In further examples of the disclosure the following is provided.

Example 1: A computer system (100; 500) for managing a man-overboard, MOB, situation for a marine vessel (1), the computer system (100; 500) comprising processing circuitry (102; 502) configured to receive an operator request (10) for activation of a MOB mode (12) for the marine vessel (1); in response to receiving the operator request (10), activate the MOB mode (12) by controlling activation of one or more sensors (14) configured to monitor surroundings (5) of the marine vessel (1); obtain sensing data (16) from said one or more sensors (14) identifying at least one detectable feature (22) of a MOB (20) in said surroundings (5) of the marine vessel (1); generate a MOB map (30) based on the sensing data (16), the MOB map (30) displaying one or more graphical indications of a position of the MOB (20) in relation to a position of the marine vessel (1); estimate said position of the MOB (20) at least based on a latest known position of said at least one detectable feature (22) and a current position of the marine vessel (1); and update the MOB map (30) based on the estimation of the position of the MOB (20).

Example 2: The computer system (100; 500) of Example 1, wherein the processing circuitry (102; 502) is further configured to identify one or more searchable areas (34) in the MOB map (30); mark a searchable area (34) as visited in response to the marine vessel (1) having visited said searchable area (34) based on its current position; and update the MOB map (30) based on the marked searchable area (34).

Example 3: The computer system (100; 500) of Example 2, wherein the processing circuitry (102; 502) is further configured to generate a search path (40) for the marine vessel (1) based on the one or more searchable areas (34) and the position of the MOB (20) in relation to the position of the marine vessel (1); and provide one or more navigational instructions (42) based on the search path (40).

Example 4: The computer system (100; 500) of Example 3, wherein the processing circuitry (102; 502) is further configured to cause autonomous control of the marine vessel (1) to follow the search path (40) based on the navigational instructions (42).

Example 5: The computer system (100; 500) of Example 4, wherein the processing circuitry (102; 502) is further configured to cause said autonomous control by maintaining a safety distance (d) from said estimation of the position of the MOB (20).

Example 6: The computer system (100; 500) of Example 5, wherein the processing circuitry (102; 502) is configured to adapt the safety distance (d) based on one or more of properties of the marine vessel (1) and obtained environmental data of the surroundings (5) of the marine vessel (1).

Example 7: The computer system (100; 500) of any of Examples 3-6, wherein the processing circuitry (102; 502) is further configured to calculate an error margin for the estimated position of the MOB (20), and adjust the search path (40) to account for the error margin.

Example 8: The computer system (100; 500) of any preceding Example, wherein the processing circuitry (102; 502) is further configured to obtain historical location data of previous MOB incidents; and estimate said position of the MOB (20) based on said historical location data.

Example 9: The computer system (100; 500) of any preceding Example, wherein the processing circuitry (102; 502) is configured to automatically perform the estimation of the position of the MOB (20) in response to a failure to obtain sensing data (16) from the one or more sensors (14).

Example 10: The computer system (100; 500) of any preceding Example, wherein the processing circuitry (102; 502) is further configured to obtain environmental data of the surroundings (5) of the marine vessel (1); and estimate said position of the MOB (20) based on said environmental data.

Example 11: The computer system (100; 500) of Example 10, wherein the obtained environmental data comprises one or more of wind speed, wind direction and current flow, and wherein the processing circuitry (102; 502) is configured to calculate a drift vector for the MOB (20) based on said one or more of wind speed, wind direction and current flow; and estimate the position of the MOB (20) based on the drift vector.

Example 12: The computer system (100; 500) of Example 11, wherein the estimation of the position of the MOB (20) is continuous, and wherein the processing circuitry (102; 502) is configured to update the estimated position of the MOB (20) at continuous intervals based on the movement of the marine vessel (1) and the calculated drift vector.

Example 13: The computer system (100; 500) of any preceding Example, wherein said at least one detectable feature (22) is a reflective element and the sensing data (16) is reflectivity data.

Example 14: The computer system (100; 500) of Example 13, wherein the reflective element comprises predetermined reflectivity properties, the processing circuitry (102; 502) being configured to map the obtained reflectivity data with said predetermined reflectivity properties to validate the identity of the MOB (20).

Example 15: The computer system (100; 500) of any preceding Example, wherein the processing circuitry (102; 502) is further configured to receive the operator request (10) for activation of the MOB mode (12) via an input device (110).

Example 16: The computer system (100; 500) of Example 15, wherein the processing circuitry (102; 502) is further configured to display a confirmation prompt at a display device (112) of the marine vessel (1) in response to receiving the operator request (10); and activate the MOB mode (12) upon receiving a confirmation input of the operator from the display device (112).

Example 17: The computer system (100; 500) of any preceding Example, wherein the processing circuitry (102; 502) is further configured to automatically deactivate the MOB mode (12) by controlling deactivation of said one or more sensors (14) in response to a successful retrieval of the MOB (20).

Example 18: The computer system (100; 500) of Example 15, wherein the processing circuitry (102; 502) is further configured to display the MOB map (30) at a display device (112) of the marine vessel (1).

Example 19: The computer system (100; 500) of any preceding Example, wherein the marine vessel (1) is a sailboat, and in response to the activation of the MOB mode (12), the processing circuitry (102; 502) is further configured to control an automatic navigation of the sailboat into the wind eye and/or control deployment of one or more sails of the sailboat.

Example 20: A marine vessel (1) comprising the computer system (100; 500) of any of Examples 1-19.

Example 21: A computer-implemented method (200) for managing a man-overboard, MOB, situation for a marine vessel (1), comprising: receiving (210), by processing circuitry (102; 502) of a computer system (100; 500), an operator request (10) for activation of a MOB mode (12) for the marine vessel (1); in response to receiving the operator request (10), activating (220), by the processing circuitry (102; 502), the MOB mode (12) by controlling activation of one or more sensors (14) configured to monitor surroundings (5) of the marine vessel (1); obtaining (230), by the processing circuitry (102; 502), sensing data (16) from said one or more sensors (14) identifying at least one detectable feature (22) of a MOB (20) in said surroundings (5) of the marine vessel (1); generating (240), by the processing circuitry (102; 502), a MOB map (30) based on the sensing data (16), the MOB map (30) displaying one or more graphical indications of a position of the MOB (20) in relation to a position of the marine vessel (1); estimating (250), by the processing circuitry (102; 502), said position of the MOB (20) at least based on a latest known position of said at least one detectable feature (22) and a current position of the marine vessel (1); and updating (260), by the processing circuitry (102; 502), the MOB map (30) based on the estimation of the position of the MOB (20).

Example 22: A computer program product comprising program code for performing, when executed by the processing circuitry (102; 502), the method (200) of Example 21.

Example 23: A non-transitory computer-readable storage medium comprising instructions, which when executed by the processing circuitry (102; 502), cause the processing circuitry (102; 502) to perform the method (200) of Example 21.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for managing a man-overboard, MOB, situation for a marine vessel, the computer system comprising processing circuitry configured to:
receive an operator request for activation of a MOB mode for the marine vessel;
in response to receiving the operator request, activate the MOB mode by controlling activation of one or more sensors configured to monitor surroundings of the marine vessel;
obtain sensing data from said one or more sensors identifying at least one detectable feature of a MOB in said surroundings of the marine vessel;
generate a MOB map based on the sensing data, the MOB map displaying one or more graphical indications of a position of the MOB in relation to a position of the marine vessel;
estimate said position of the MOB at least based on a latest known position of said at least one detectable feature and a current position of the marine vessel; and
update the MOB map based on the estimation of the position of the MOB.

2. The computer system of claim 1, wherein the processing circuitry is further configured to:
identify one or more searchable areas in the MOB map;
mark a searchable area as visited in response to the marine vessel having visited said searchable area based on its current position; and
update the MOB map based on the marked searchable area.

3. The computer system of claim 2, wherein the processing circuitry is further configured to:
generate a search path for the marine vessel based on the one or more searchable areas and the position of the MOB in relation to the position of the marine vessel; and
provide one or more navigational instructions based on the search path.

4. The computer system of claim 3, wherein the processing circuitry is further configured to cause autonomous control of the marine vessel to follow the search path based on the navigational instructions.

5. The computer system of claim 4, wherein the processing circuitry is further configured to cause said autonomous control by maintaining a safety distance from said estimation of the position of the MOB.

6. The computer system of claim 5, wherein the processing circuitry is configured to adapt the safety distance based on one or more of properties of the marine vessel and obtained environmental data of the surroundings of the marine vessel.

7. The computer system of claim 3, wherein the processing circuitry is further configured to calculate an error margin for the estimated position of the MOB, and adjust the search path to account for the error margin.

8. The computer system of claim 1, wherein the processing circuitry is further configured to:
obtain historical location data of previous MOB incidents; and
estimate said position of the MOB based on said historical location data.

9. The computer system of claim 1, wherein the processing circuitry is configured to automatically perform the estimation of the position of the MOB in response to a failure to obtain sensing data from the one or more sensors.

10. The computer system of claim 1, wherein the processing circuitry is further configured to:
obtain environmental data of the surroundings of the marine vessel; and
estimate said position of the MOB based on said environmental data.

11. The computer system of claim 10, wherein the obtained environmental data comprises one or more of wind speed, wind direction and current flow, and wherein the processing circuitry is configured to:
calculate a drift vector for the MOB based on said one or more of wind speed, wind direction and current flow; and
estimate the position of the MOB based on the drift vector.

12. The computer system of claim 11, wherein the estimation of the position of the MOB is continuous, and wherein the processing circuitry is configured to update the estimated position of the MOB at continuous intervals based on the movement of the marine vessel and the calculated drift vector.

13. The computer system of claim 1, wherein said at least one detectable feature is a reflective element and the sensing data is reflectivity data.

14. The computer system of claim 13, wherein the reflective element comprises predetermined reflectivity properties, the processing circuitry being configured to map the obtained reflectivity data with said predetermined reflectivity properties to validate the identity of the MOB.

15. The computer system of claim 1, wherein the processing circuitry is further configured to receive the operator request for activation of the MOB mode via an input device.

16. The computer system of claim 15, wherein the processing circuitry is further configured to display the MOB map at a display device of the marine vessel.

17. A marine vessel comprising the computer system of claim 1.

18. A computer-implemented method for managing a man-overboard, MOB, situation for a marine vessel, comprising:
receiving, by processing circuitry of a computer system, an operator request for activation of a MOB mode for the marine vessel;
in response to receiving the operator request, activating, by the processing circuitry, the MOB mode by controlling activation of one or more sensors configured to monitor surroundings of the marine vessel;
obtaining, by the processing circuitry, sensing data from said one or more sensors identifying at least one detectable feature of a MOB in said surroundings of the marine vessel;
generating, by the processing circuitry, a MOB map based on the sensing data, the MOB map displaying one or more graphical indications of a position of the MOB in relation to a position of the marine vessel;
estimating, by the processing circuitry, said position of the MOB at least based on a latest known position of said at least one detectable feature and a current position of the marine vessel; and
updating, by the processing circuitry, the MOB map based on the estimation of the position of the MOB.

19. A computer program product comprising program code for performing, when executed by the processing circuitry, the method of claim 18.

20. A non-transitory computer-readable storage medium comprising instructions, which when executed by the processing circuitry, cause the processing circuitry to perform the method of claim 18.
